(19) United States
(12) Patent Application Publication
(10) Pub. No.: US 2010/0060924 A1
(43) Pub. Date: Mar. 11, 2010

(54) METHOD, SYSTEM, AND DRIVER FOR VIRTUAL FULFILLMENT

(76) Inventors: Holden Caine, Boulder, CO (US); All Seymen Ertas, Rochester, NY (US)

Correspondence Address: Woods Oviatt Gilman LLP, 700 Crossroads Bldg, 2 State St., Rochester, NY, 14614, US

(21) Appl. No.: 12/205,400

(22) Filed: Sep. 5, 2008

(51) Int. Cl. G06F 3/12; G06Q 10/00; G06Q 50/00

(52) U.S. Cl. 358/1.15; 705/30

(57) ABSTRACT

A system for virtual fulfillment is also disclosed. The system has one or more distributed fulfillment devices. The system also has one or more fulfillment controllers coupled to the one or more distributed fulfillment devices. The system further has a client and a virtual fulfillment driver installed on the client. The virtual fulfillment driver is configured to: a) render a document; b) bundle the rendered document into an order for later communication to the one or more fulfillment controllers; and c) communicate the order to the one or more fulfillment controllers. A related method, virtual fulfillment driver, and machine executable instructions embodied on a machine readable medium are also disclosed.

### FIELD OF THE INVENTION

The claimed invention generally relates to virtual fulfillment and more particularly to a method, system, and driver for virtual fulfillment which allows for agglomeration, review, and modification of one or more fulfillment orders.

### BACKGROUND OF THE INVENTION

Users of personal computers, laptops, personal digital assistants, and other electronic devices have a variety of local printing options available to them, such as inkjet printers and laser printers. The user devices may be directly wired or wirelessly coupled to these local printers. Given the nearby locations of such printers relative to the user, it is very convenient for the user to pick-up multiple print jobs throughout the day since the printer is easily accessible to the user. Furthermore, the user is often under little pressure to gather his or her print jobs from such an easily accessible printer because there may be few people printing to the local printer.

The low-price point of many local printing devices has made them common-place items in households and businesses. Unfortunately, although these printers are often adequate for everyday printing needs, they do not offer the high image quality, volume, and finishing options that are available on high-end printers. For example, such high-end printers are capable of generating photo-quality prints far superior to the typical home printer. Many high-end printers can print large orders in a very short time. Other high-end printers can print on continuous roll-based media to enable the printing of banners, posters, large signs, and blue prints. Unfortunately, such high-end printers often cost hundreds of thousands of dollars and are well-outside of the reach of the typical user's ability or desire to own.

As a result, printing businesses often will purchase a high-end printer and make it available to their customers. If the printing business can keep the machine fully-utilized by many users, then the participating users pay a small share of the cost to use the high-end machine while receiving the benefit of the higher quality output and capabilities of the high-end machine. Unfortunately, utilization of these high-end printing machines is often inefficient, which can drive up the price per print or simply prevent certain high-end machines from being available. For example, users who want to print on these high-end printers may bring their digital documents to the printing business. This operational model discourages casual use of the high-end machines since it is inconvenient. More recently, printing businesses have placed their high-end printing machines on networks, such as the internet, enabling users to send documents to the high-end printers for printing. While this increases the initial convenience for a user, many users end-up avoiding this service since it quickly becomes unmanageable for them to track multiple print jobs at the remote printer or pick-up all of the separate orders. To combat this, some printing businesses provide the option to ship each print order, but this becomes expensive to have many small print jobs shipped separately. As a result, high-end printing services are underutilized.

High-end printing is no longer limited to paper sheet media. In fact, there are many new ways that documents may be fulfilled, including calendars, bound books, magazines, novelty items (for example, coffee mugs), souvenir items (such as t-shirts), banners, and decals. Unfortunately, while the options for fulfillment continue to expand, the factors which cause such high-end fulfillment services to be underutilized are still not being addressed.

Therefore, there is a need for a virtual fulfillment method and system which will encourage users to take advantage of remote fulfillment options in an efficient and convenient manner.

### SUMMARY OF THE INVENTION

A virtual fulfillment driver, accessible within an application program is disclosed. The virtual fulfillment driver has a rendering engine configured to prepare one or more documents for fulfillment by one or more remote fulfillment controllers. The virtual fulfillment driver also has an order bundler configured to bundle one or more of the prepared documents into an order. The virtual fulfillment driver further has a communication manager configured to communicate the order to the one or more remote fulfillment controllers.

A system for virtual fulfillment is also disclosed. The system has one or more distributed fulfillment devices. The system also has one or more fulfillment controllers coupled to the one or more distributed fulfillment devices. The system further has a client and a virtual fulfillment driver installed on the client. The virtual fulfillment driver is configured to: a) render a document; b) bundle the rendered document into an order for later communication to the one or more fulfillment controllers; and c) communicate the order to the one or more fulfillment controllers.

A method of virtual fulfillment is also disclosed. A document is rendered. The rendered document is bundled into an order for later communication to a remote fulfillment controller. The order is communicated to the remote fulfillment controller. The communicated order is fulfilled.

A set of machine executable instructions embodied on a machine readable medium for virtual fulfillment is also disclosed. The set of machine executable instructions has instructions for rendering a document; instructions for bundling the rendered document into an order for later communication to a remote fulfillment controller; and instructions for communicating the order to the remote fulfillment controller.

The claimed invention, and its objects and advantages, will become more apparent in the detailed description presented below.

### BRIEF DESCRIPTION OF THE DRAWINGS

FIG. 1 schematically illustrates one embodiment of a virtual fulfillment driver;

FIG. 2 schematically illustrates one embodiment of a system for virtual fulfillment; and

FIG. 3 illustrates one embodiment of a method for virtual fulfillment.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

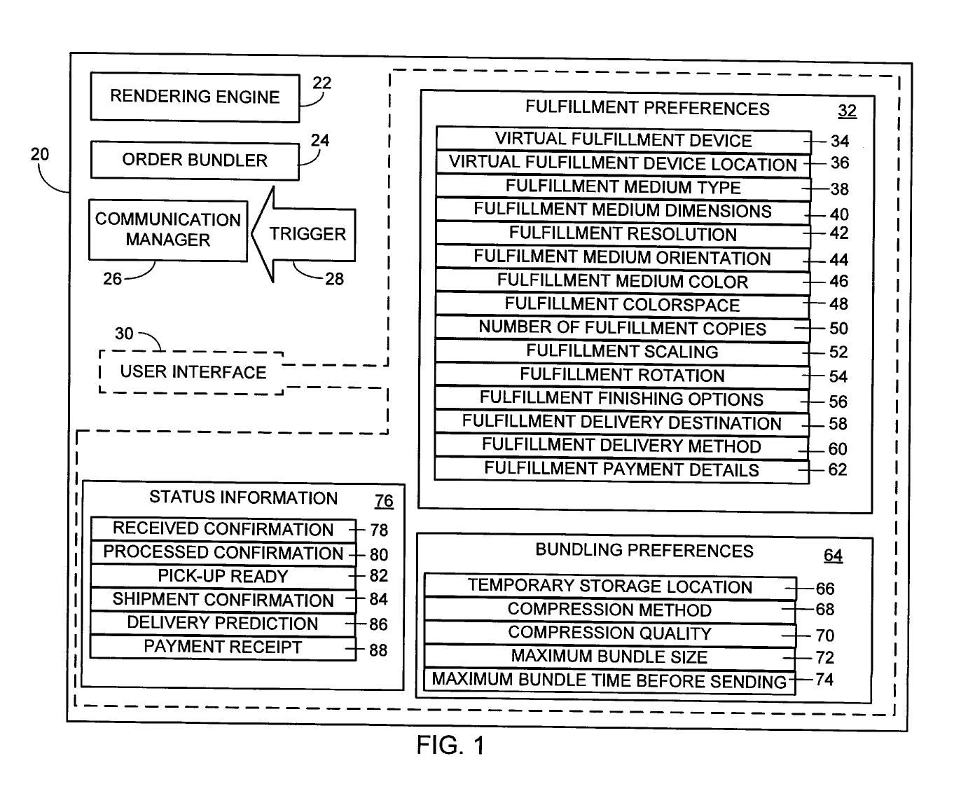

One way to encourage the use of remote fulfillment devices is by providing a virtual fulfillment driver which can be installed on a client machine run by the user. FIG. 1 schematically illustrates one embodiment of a virtual fulfillment driver 20. The virtual fulfillment driver 20 is preferably accessible within an application program running on a client's machine similar to the way local print drivers are accessible to the user. The virtual fulfillment driver 20 has a rendering engine 22 configured to prepare one or more documents for fulfillment by one or more fulfillment controllers. Applications running on the client's machine may be able to create, open, edit, and/or select a variety of types of documents, including, but not limited to a digital image, a digital photograph, a digital publication, a digital scrapbook, a digital book, a digital card, a word processing document, a spreadsheet, a presentation, and a hypertext markup language (HTML) document. The one or more fulfillment controllers can be any computer, server, microprocessor, application specific integrated circuit (ASIC), analog circuitry, digital circuitry, or any combination or plurality thereof which is configured to accept data and provide it to a fulfillment device. The controller can be thought-of as the front end for the fulfillment device.

In preparing the one or more documents for fulfillment, in some embodiments, the rendering engine 22 may rasterize the one or more documents into fulfillable pixels. If the fulfillment will generate color output, then the rendering engine 22 may convert each fulfillable pixel into multiple color channels. Some documents may already be pixilated. In this case, the rendering engine may scale the number of pixels to be compatible with the fulfillment controller. In other embodiments, the rendering engine 22 may convert the one or more documents to a page description language (PDL) which may be understood by the remote fulfillment controller. Suitable examples of PDL's include, but are not limited to Comtec printer control language (CPCL); device independent (DVI); Epson standard code for printers (ESC/P); expanded standard code for printers (ESC/P2); intelligent printer data stream (IPDS); Kyocera page description language (KPDL); personal printer data stream (PPDS); metacode; portable document format (PDF); postscript; printer command language (PCL); Samsung printer language (SPL); scalable vector graphics (SVG); hypertext markup language paper specification (XPS); and Zenographics ZjStream page description language (ZJS).

The virtual fulfillment driver also has an order bundler 24 which is configured to bundle one or more of the prepared documents from the rendering engine 22 into an order. In some embodiments, the order bundler 24 may compress the order as a way to reduce the amount of data which will ultimately be sent to the remote fulfillment controller. The order bundler 24 may store the order locally on the client machine, or the order bundler 24 may store the order on the remote fulfillment controller. In either case, it is important to note that the order can not be fulfilled yet, because it is only being stored. The order bundler 24 may combine the order with a previously bundled order, thereby preventing many smaller jobs from being fulfilled separately by the remote fulfillment controller. The additional advantage provided by the order bundler 24, when configured to store the order or the combined order on the fulfillment controller, is that when the time comes to fulfill the order, the user will not need to wait for a transmission of the bulk of the order data to occur, since it may already have taken place.

The virtual fulfillment driver 20 also has a communication manager 26 which is configured to communicate the order to the one or more remote fulfillment controllers. This communication action is the one which actually provides an instruction or a request to the fulfillment controller to begin the fulfillment. If the order communication refers to an order which has already been stored on the fulfillment controller, then the order does not need to be sent to the fulfillment controller. If the order communication refers to an order which is stored on the client machine, then the virtual fulfillment driver 20 is configured to send the order to the fulfillment controller.

The communication manager 26 may be configured to communicate the order to the fulfillment controller in response to a user-generated action. For example, a user may decide that they have used the virtual fulfillment driver 20 enough times to create a large fulfillment order and manually initiate the order communication. Optionally, the communication manager 26 may be configured to communicate the order in response to a trigger 28. Suitable examples of a trigger 28 include, but are not limited to a) a situation where a threshold file size for the order has been reached; b) a situation where a threshold time has passed since the order was originally first bundled; c) a situation where a threshold quantity of fulfillment copies has been reached in the order; or d) a threshold cost of the order has been reached. By using the order bundler 24 to agglomerate fulfillment jobs for a period, and then only initiating when a trigger 28 is received, users will avoid the need to send many small jobs separately for fulfillment, the need to pay separate shipment costs for a series of small orders, or the need to visit a retail location multiple times without having to do all of their printing from the client machine at the same time.

The communication manager 26 may also be configured to prompt a user for confirmation of the order to be communicated prior to making the order communication. For example, if over the course of a week, a user used the virtual fulfillment driver 20 to print photos on several different days and at several different times, the order bundler 24 would have combined all of these print jobs into one order. Whether initiated by the user or by a trigger 28, the communication manager 26 could display or summarize the items in the order to the user for review. The user could remove an item from the order or modify the order in other ways, such as changing quantities of each item. After the user confirmed or modified the order, then the communication manager 26 would communicate the order.

The virtual fulfillment driver 20 may optionally have a user interface 30. The user interface 30 may be configured to store, display, and enable the changing or selection of one or more fulfillment preferences 32. Some non-limiting examples of suitable fulfillment preferences 32 may include:

1) a virtual fulfillment device 34 for which the order should be rendered and bundled;

2) a virtual fulfillment device location 36;

3) a fulfillment medium type 38. Depending on the fulfillment device selected, the media available for selection may include plain paper, coated paper, photo paper, cardstock, transparencies, velum, cardboard, coffee mugs, pens, boxes, t-shirts, calendars, and even electronic publications such as web pages.

4) fulfillment medium dimensions 40;

5) a fulfillment resolution 42;

6) a fulfillment medium orientation 44;

7) a fulfillment medium color 46;

8) a fulfillment colorspace 48. For example black-only, grayscale, CMYK color, RGB color, or even five or six component color spaces may be available;

9) a number of fulfillment copies 50;

10) a fulfillment scaling 52;

11) a fulfillment rotation 54;

12) fulfillment finishing options 56;

13) a fulfillment delivery destination 58. Possible destinations could be a residential mailing address or a retail location;

14) a fulfillment delivery method 60. Examples may include first class mail, priority mail, express mail, United Parcel Service, or FedEx; and

15) fulfillment payment details 62. This preference may be used to store default bank accounts or charge cards and their corresponding billing information to pay for the order.

Further, the user interface 30 may be configured to offer additional fulfillment preferences prior to the communication of the order to the fulfillment controller. For example, the user interface 30 may offer a backup CD of all files included in the order.

The user interface 30 may also be configured to store, display, and enable the changing or selection of one or more bundling preferences 64. Some non-limiting examples of suitable bundling preferences 64 may include:

1) a temporary storage location 66. The storage location may be a local path or a remote location on the fulfillment controller;

2) a compression method 68;

3) a compression quality 70;

4) a maximum bundle size 72. For example, if the maximum bundle size 72 is exceeded, then a trigger 28 may be generated for the communication manager 26; and

5) a maximum bundle time 74. For example, if the maximum bundle time 74 has passed since a bundle was first created, then a trigger 28 may be generated for the communication manager 26.

The user interface 30 may also be configured to receive status information 76 from the one or more remote fulfillment controllers. The user interface 30 may further be configured to display the status information. Some non-limiting examples of status information which may be displayed at times by the user interface 30 include:

1) a confirmation 78 that the order has been communicated to the one or more remote fulfillment controllers;

2) a confirmation 80 that a fulfillment order has been processed;

3) a confirmation that a fulfillment order is ready to be picked-up 82;

4) a confirmation that a fulfillment order has been shipped 84;

5) a prediction of a fulfillment order delivery time and date 86; and

6) a receipt for payment 88.

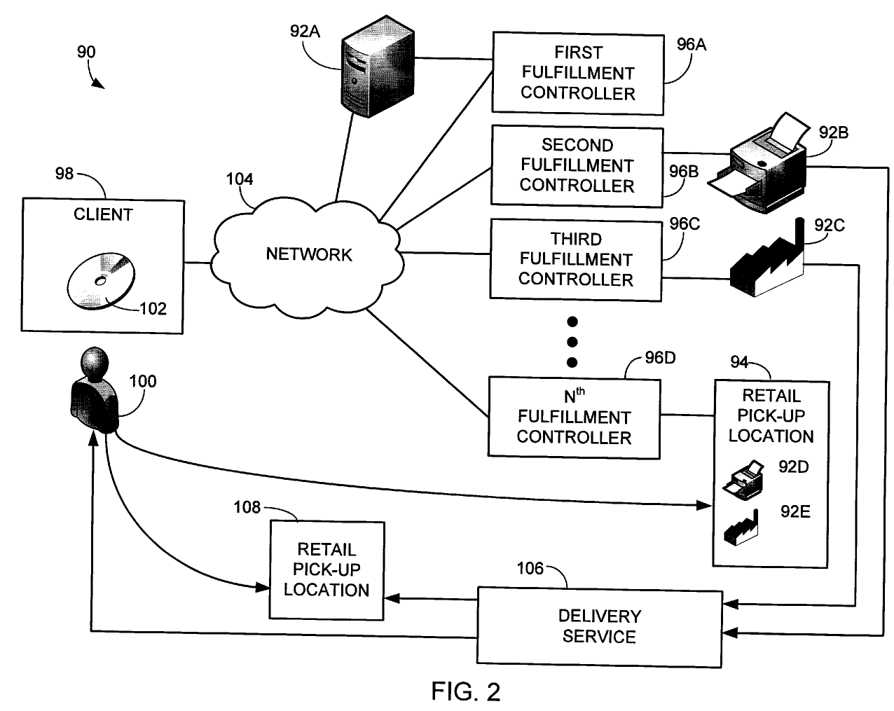

FIG. 2 schematically illustrates one embodiment of a system for virtual fulfillment 90. The system 90 has one or more distributed fulfillment devices 92A-92E. Examples of the distributed fulfillment devices may include a network server 92A which can be used to publish a document on the web, for example, using a hypertext markup language (HTML). Other distributed fulfillment devices may include a printer or plotter 92B. Still other distributed fulfillment devices may include manufacturing system 92C which takes the documents in the bundle to be imaged and can create non-traditional printed objects from them, such as personalized calendars, coffee mugs, pens, decals, banners, and souvenirs. Still other distributed fulfillment devices may include printers 92D or manufacturing systems 92E which are located at a retail pick-up location 94.

The system 90 also has one or more distributed fulfillment controllers 96A-96D coupled to the one or more distributed fulfillment devices 92A-92E. The distributed fulfillment controllers 96A-96D may be computers, servers, microprocessors, ASIC's, digital circuitry, analog circuitry, or any combination or plurality thereof. Although the distributed fulfillment controllers 96A-96D are illustrated as being separate from the fulfillment devices 92A-92E, in other embodiments, the fulfillment controllers may be integral with the fulfillment devices.

The system 90 has a client 98 operable by a user 100. The client 98 may be a computer, laptop, personal digital assistant (PDA), cellular phone, wireless phone, camcorder, digital camera, or smartphone. A virtual fulfillment driver, the features of which have been discussed above with regard to FIG. 1, is installed on the client 98. The virtual fulfillment driver may be removably or permanently stored as a set of machine executable instructions on a machine readable medium 102. The machine readable medium 102 may include a randomly accessible memory (RAM), a read-only memory (ROM), a re-writable memory, a flash drive, an SD card, a memory stick, a magnetic tape, a floppy disk, a compact disc, a DVD, an optical drive, or a magnetic hard drive.

The virtual fulfillment driver on the client 98 is configured to render a document, bundle the rendered document into an order for later communication to the one or more fulfillment controllers 96A-96D, and communicate the order to the one or more fulfillment controllers 96A-96D. It is important to recall that as part of the bundling process, the order may be stored locally on the client 98 or remotely one of the fulfillment controllers 96A-96D. The “communication” of the order may simply be an initiation of the fulfillment order if the order is already stored on a fulfillment controller 96A-96D. If the order is not already stored on a fulfillment controller 96A-96D, then the communication of the order may also include the transfer of the order to the fulfillment controller 96A-96D. The client 98 may be linked to the fulfillment controllers 96A-96D by a network 104.

Once the order has been communicated and fulfilled, the fulfillment output from distributed fulfillment devices 92D, 92E (which are located at a retail pick-up location 94) may be picked-up by the user 100. Fulfillment devices 92B, 92C which are not located at a pick-up location can use a delivery service 106 to deliver the fulfillment output to the user 100. Alternatively, the delivery service 106 may be used to deliver the fulfillment output to a retail pick-up location 108 where the user 100 can retrieve the fulfillment output. If the fulfillment device 92A is a network server, then the fulfillment output may be electronically available for viewing via the network 104. Suitable examples of such electronically available fulfillment output may include electronic greeting cards, electronic scrapbooks, and web pages. Furthermore, after the order is fulfilled, the one or more remote fulfillment controllers may be configured to store the order for a predetermined period of time, for instance, three weeks, so that reordering and/or remanufacturing is possible in case the customer would like additional copies or manufacturing defects occurred that require rework.

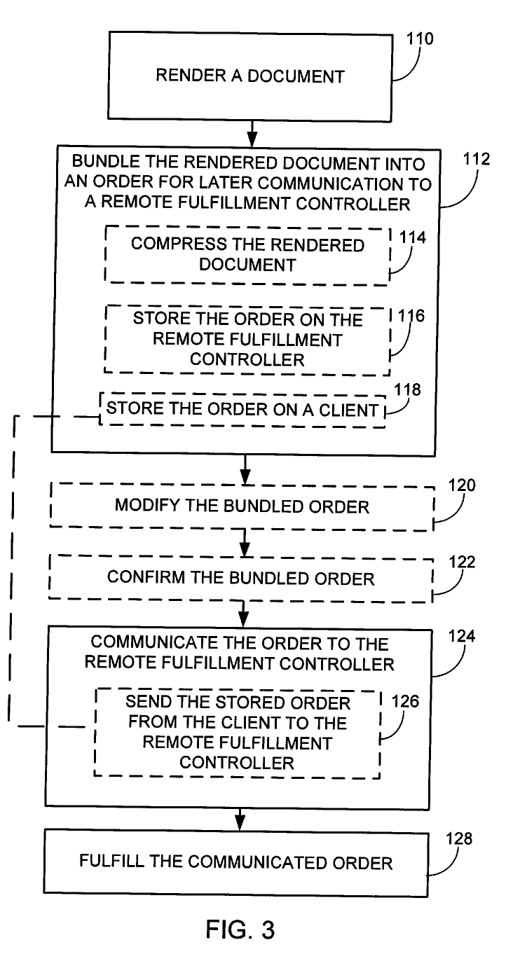

FIG. 3 illustrates one embodiment of a method for virtual fulfillment. A document is rendered 110. As mentioned above the documents may include, but are not limited to a digital photograph, a digital image, a digital publication, a digital scrapbook, a digital book, a digital card, a word processing document, a spreadsheet, a presentation, and an HTML document. The rendering process 110 may include rasterizing the document into fulfillable pixels which may include a single or multiple color channels. The rendering process 110 may optionally include converting the document to a page description language, examples of which have been cited above. The rendering process 110 may optionally include determining that the document is already in a native format supported by the fulfillment controller, and therefore, not changing the document if it is already compatible with the fulfillment controller.

The rendered document is bundled 112 into an order for later communication to a remote fulfillment controller. Bundling 112 the rendered document may optionally include compressing 114 the rendered document. In some embodiments, bundling 112 the rendered document may include storing 116 the rendered document on the remote fulfillment controller. In other embodiments, bundling 112 the rendered document may include storing 118 the order on a client. The bundled order may optionally be modified 120. For example, one or more documents from the order may be deleted, or fulfillment properties relating to the one or more documents may be changed. The bundled order may optionally be confirmed 122. In addition, an additional fulfillment offering may be made by, for example, the virtual fulfillment driver or remote fulfillment controller, prior to communicating the order to the remote fulfillment controller. For example, the additional fulfillment offering may be a backup CD for all files included in the order.

The order is then communicated 124 to the remote fulfillment controller. If the bundled order was already stored 116 on the fulfillment controller, the communication 124 of the order is an initiation of the fulfillment of the order by the fulfillment controller. If the bundled order was stored 118 on the client, then the communication 124 of the order also involves sending 126 the stored order from the client to the fulfillment controller. Finally, the communicated order is fulfilled 128. If an order fails to arrive to the fulfillment controller in a reasonable period of time, any data previously stored on the fulfillment controller is automatically deleted.

Having thus described several embodiments of the claimed invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A virtual fulfillment driver, accessible within an application program, comprising:
a rendering engine configured to prepare one or more documents for fulfillment by one or more remote fulfillment controllers;
an order bundler configured to bundle one or more of the prepared documents into an order; and
a communication manager configured to communicate the order to the one or more remote fulfillment controllers.

2. The virtual fulfillment driver of claim 1, further comprising a user interface.

3. The virtual fulfillment driver of claim 2, wherein the user interface is configured to store, display, and enable the changing or selection of one or more fulfillment preferences.

4. The virtual fulfillment driver of claim 3, wherein the one or more fulfillment preferences are selected from the group consisting of:
a virtual fulfillment device;
a virtual fulfillment device location;
a fulfillment medium type;
fulfillment medium dimensions;
a fulfillment medium resolution;
a fulfillment medium orientation;
a fulfillment medium color;
a fulfillment colorspace;
a number of fulfillment copies;
a fulfillment scaling;
a fulfillment rotation;
fulfillment finishing options;
a fulfillment delivery destination;
a fulfillment delivery method; and
fulfillment payment details.

5. The virtual fulfillment driver of claim 2, wherein the user interface is configured to store, display, and enable the changing or selection of one or more bundling preferences.

6. The virtual fulfillment driver of claim 5, wherein the one or more bundling preferences are selected from the group consisting of:
a temporary storage location;
a compression method;
a compression quality;
a maximum bundle size; and
a maximum bundle time;

7. The virtual fulfillment driver of claim 2, wherein:
the communication manager is further configured to receive a status information from the one or more remote fulfillment controllers; and
the user interface is configured to display the status information.

8. The virtual fulfillment driver of claim 7, wherein the status information is selected from the group consisting of:
a confirmation that the order has been communicated to the one or more remote fulfillment controllers;
a confirmation that a fulfillment order has been processed;
a confirmation that a fulfillment order is ready to be picked-up;
a confirmation that a fulfillment order has been shipped;
a prediction of a fulfillment order delivery time and date; and
a receipt for payment.

9. The virtual fulfillment driver of claim 1, wherein the order bundler is further configured to compress the order.

10. The virtual fulfillment driver of claim 1, wherein the order bundler is further configured to store the order on a client.

11. The virtual fulfillment driver of claim 10, wherein the communication manager is further configured to send the stored order from the client to the one or more remote fulfillment controllers.

12. The virtual fulfillment driver of claim 1, wherein the order bundler is further configured to store the order on the one or more remote fulfillment controllers.

13. The virtual fulfillment driver of claim 12, wherein the one or more remote fulfillment controllers are configured to store the order for a predetermined period of time after the order is fulfilled.

14. The virtual fulfillment driver of claim 1, wherein the order bundler is further configured to combine the order with a previously bundled order.

15. The virtual fulfillment driver of claim 1, wherein the communication manager is further configured to communicate the order to the one or more remote fulfillment controllers in response to a trigger.

16. The virtual fulfillment driver of claim 15, wherein the trigger is selected from the group consisting of:
a threshold file size has been reached;
a threshold time has passed;
a threshold quantity of fulfillment copies has been reached;
a threshold cost of the order has been reached;
a user command to communicate has been received.

17. The virtual fulfillment driver of claim 1, wherein the communication manager is further configured to communicate the order to the one or more remote fulfillment controllers following a confirmation of the order by a user.

18. The virtual fulfillment driver of claim 1, wherein fulfillment available from the one or more remote fulfillment controllers is selected from the group consisting of:
black and white printing;
color printing;
photo printing;
poster printing;
blueprint printing;
calendar printing;
book printing;
magazine printing;
pamphlet printing;
online publishing;
coffee mug printing;
novelty item printing;
souvenir printing;
banner printing; and
decal printing.

19. The virtual fulfillment driver of claim 18, wherein the user interface is configured to offer additional fulfillment prior to communicating the order to the one or more remote fulfillment controllers.

20. The virtual fulfillment driver of claim 1, wherein the one or more documents are selected from the group consisting of:
a digital photograph;
a digital image;
a digital publication;
a digital scrapbook;
a digital book;
a digital card;
a word processing document;
a spreadsheet;
a presentation; and
a hypertext mark-up language (HTML) document.

21. A system for virtual fulfillment, comprising:
one or more distributed fulfillment devices;
one or more fulfillment controllers coupled to the one or more distributed fulfillment devices;
a client; and
a virtual fulfillment driver installed on the client and configured to:
a) render a document;
b) bundle the rendered document into an order for later communication to the one or more fulfillment controllers; and
c) communicate the order to the one or more fulfillment controllers to fulfill the order using the one or more distributed fulfillment devices.

22. The system of claim 21, wherein the one or more distributed fulfillment devices are selected from the group consisting of:
a network server;
a printer;
a plotter; and
a manufacturing system.

23. The system of claim 21, further comprising a delivery service.

24. The system of claim 21, further comprising a retail pick-up location.

25. A method of virtual fulfillment, comprising:
rendering a document;
bundling the rendered document into an order for later communication to a remote fulfillment controller;
communicating the order to the remote fulfillment controller; and
fulfilling the communicated order.

26. The method of claim 25, wherein rendering the document comprises rasterizing the document into fulfillable pixels.

27. The method of claim 26, wherein rendering the document further comprises separating each fulfillable pixel into multiple color channels.

28. The method of claim 25, wherein rendering a document comprises converting the document to a page description language.

29. The method of claim 28, wherein the page description language is selected from the group consisting of:
Comtec printer control language (CPCL);
device independent (DVI);
Epson standard code for printers (ESC/P);
expanded standard code for printers (ESC/P2)
intelligent printer data stream (IPDS);
Kyocera page description language (KPDL);
personal printer data stream (PPDS);
metacode;
portable document format (PDF);
postscript;
printer command language (PCL);
Samsung printer language (SPL);
scalable vector graphics (SVG);
hypertext markup language paper specification (XPS); and
Zenographics ZjStream page description language (ZJS).

30. The method of claim 25, wherein bundling the rendered document into the order further comprises compressing the rendered document.

31. The method of claim 25, wherein bundling the rendered document into the order further comprises storing the order on a client.

32. The method of claim 31, wherein communicating the order to the remote fulfillment controller further comprises:
sending the stored order from the client to the remote fulfillment controller.

33. The method of claim 25, wherein bundling the rendered document into the order further comprises storing the order on the remote fulfillment controller.

34. The method of claim 33, wherein the order is stored for a predetermined period of time after the order is fulfilled.

35. The method of claim 25, wherein bundling the rendered document into the order further comprises combining the order with a previously bundled order.

36. The method of claim 25, further comprising:
confirming the bundled order prior to communicating the order.

37. The method of claim 25, further comprising:
modifying the bundled order prior to communicating the order.

38. The method of claim 25, further comprising:
offering additional fulfillment prior to communicating the order to the remote fulfillment controller.

39. A set of machine executable instructions embodied on a machine readable medium for virtual fulfillment, comprising:
instructions for rendering a document;
instructions for bundling the rendered document into an order for later communication to a remote fulfillment controller; and
instructions for communicating the order to the remote fulfillment controller.
